(19) United States
(12) Patent Application Publication
(10) Pub. No.: US 2017/0357463 A1
(43) Pub. Date: Dec. 14, 2017

(54) CHARACTERIZATION PROFILES OF MEMORY DEVICES

(71) Applicant: Hewlett Packard Enterprise Development LP, Houston, TX (US)

(72) Inventors: Naveen Muralimanohar, Palo Alto, CA (US); Cullen E. Bash, Palo Alto, CA (US)

(21) Appl. No.: 15/181,541

(22) Filed: Jun. 14, 2016

(51) Int. Cl. G06F 3/06

(52) U.S. Cl. CPC G06F 3/0631; G06F 3/0616; G06F 3/0673; G06F 3/0638

(57) ABSTRACT

An example device in accordance with an aspect of the present disclosure includes a characterization engine and an allocation engine. The characterization engine is to receive information and characterizes expected temperature exposure of a memory device, to store a characterization profile of a plurality of memory devices of a computing system. The characterization engine is to refer to the characterization profile to identify the expected temperature exposure for a given memory device.

### BACKGROUND

The performance of memory devices can be affected by temperature. Cooling techniques can be used to lower the temperature of different components of computing systems. However, temperature variations can still exist between the components.

### BRIEF DESCRIPTION OF THE DRAWINGS/FIGURES

FIG. 1 is a block diagram of a controller including a characterization engine and an allocation engine according to an example.

FIG. 2 is a block diagram of a system including computer-readable media and instructions according to an example.

FIG. 3 is a block diagram of a computing device including a controller according to an example.

FIG. 4 is a flow chart based on identifying expected temperature exposure based on a characterization profile according to an example.

FIG. 5 is a flow chart based on prioritizing cooler memory devices and warmer memory devices according to an example.

### DETAILED DESCRIPTION

A crossbar memory architecture of memristor memory devices can provide high-density memory. However, characteristics of the crossbar architecture (e.g., biasing unselected wordlines and bitlines and the use of a selector to select a memristor cell) can result in leakage current (i.e., “sneak” current). Memristor cell memory device current leakage (e.g., the leakage current of a selector) can increase with operating temperature of the memory. Memory devices, such as memory chips in a server or blade computing device, can operate at different temperatures based on cooling techniques used in the computing device and the proximity of a given memory device to a given location, such as whether the location includes or is near a cooling source or heat source.

To address such issues, example implementations described herein may characterize expected temperature exposure of a memory device, store a characterization profile of a plurality of memory devices based on expected temperature exposures, identify the expected temperature exposure based on the characterization profile for a given memory device, and prioritize page allocation to cooler memory devices. In this manner, example implementations described herein may enjoy thermal aware page allocation and scheduling policies to utilize low temperature regions of memory, associated with less leakage. This can improve/decrease usage of read energy (e.g., by up to 9%) and write energy (e.g., by up to 40%). Furthermore, example implementations can improve write performance. Because leakage current through memristor cells can have a direct impact on write performance, example implementations can direct more requests to low-temperature memory devices to reduce write latency (e.g., by up to 50%). Such improvements can be achieved based on several different memory usage optimizations to exploit memory device thermal characteristics.

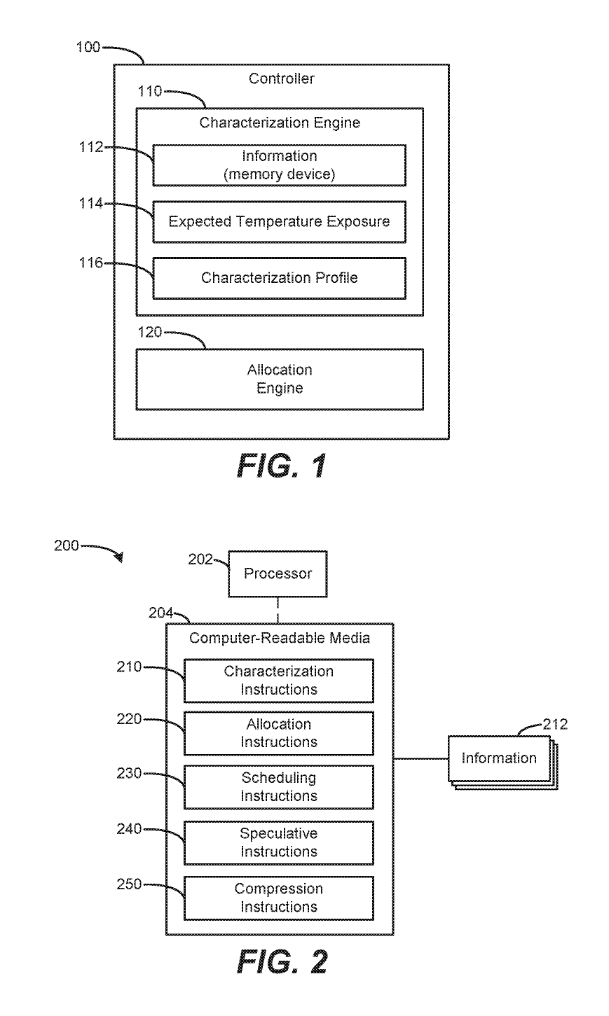

FIG. 1 is a block diagram of a controller 100 including a characterization engine 110 and an allocation engine 120 according to an example. The characterization engine 110 is associated with information 112, expected temperature exposure 114, and characterization profile 116.

The characterization engine 110 is to receive information 112 regarding a memory device, and characterize expected temperature exposure 114 of the memory device based on the information 112. The characterization engine 110 also is to store the characterization profile 116 for a plurality of memory devices of a computing system. The characterization profile 116 is based on the expected temperature exposures 114 for the plurality of memory devices. The characterization engine 110 can refer to the characterization profile 116 to identify the expected temperature exposure 114 for a given memory device (which can be inferred from the information 112 of other memory devices, even if no specific information 112 has been collected for a given memory device whose expected temperature exposure is being identified). The allocation engine 120 is to prioritize page allocation to the memory device based on the expected temperature exposure 114. For example, cooler memory devices are given priority for page allocation. In some alternate example implementations, a warmer memory device may be given priority for page allocation (e.g., based on a characteristic of the data) as described in further detail below.

In some example implementations, the information 112 for a memory device can be provided as a location of the memory device, e.g., in a region of a computing system. The characterization engine 110 can then identify the location relative to heat sources and cooling/airflow in the computing system, to infer the expected temperature exposure of the given memory device, e.g., relative to other memory devices and their locations. This is an example of how the characterization engine 110 can identify which memory devices are cooler, and which are warmer. In alternate examples, the characterization engine 110 can receive information 112 that more directly relates to temperatures of memory devices, e.g., based on a temperature sensor near memory devices, temperature sensors on the memory devices, and/or temperature sensors on the chips of the memory devices. Such temperature information can be used to determine expected temperature exposure 114 for different memory devices real-time, and also can be used to build a stored characterization profile 116 that can be used to identify expected temperature exposure 114 for a given memory device without a need for real-time analysis or checks of current temperatures. Thus, the characterization profile 116 can represent general temperature characteristics of memory devices in a given computing system, which can identify the airflow, cooling sources, and heat sources in the computing system.

The allocation engine 120 can reduce energy by prioritizing page allocation to cooler memory devices, as characterized by the characterization engine 110. The allocation engine 120 can also schedule more requests to cooler memory devices to benefit from faster writes (in some example implementations, a scheduling engine/instructions can provide scheduling functionality).

Example implementations can be achieved in software and/or hardware, such as in a hardware layers and/or firmware layers, operating system (OS), application, and other software layers, etc. As described herein, the term “engine” may include electronic circuitry for implementing functionality consistent with disclosed examples. For example, engines 110 and 120 represent combinations of hardware devices (e.g., processor and/or memory) and programming to implement the functionality consistent with disclosed implementations. In examples, the programming for the engines may be processor-executable instructions stored on a non-transitory machine-readable storage media, and the hardware for the engines may include a processing resource to execute those instructions. An example system (e.g., a computing device), such as a system including controller 100, may include and/or receive the tangible non-transitory computer-readable media storing the set of computer-readable instructions. As used herein, the processor/processing resource may include one or a plurality of processors, such as in a parallel processing system, to execute the processor-executable instructions. The memory can include memory addressable by the processor for execution of computer-readable instructions. The computer-readable media can include volatile and/or non-volatile memory such as a random access memory (“RAM”), magnetic memory such as a hard disk, floppy disk, and/or tape memory, a solid state drive (“SSD”), flash memory, phase change memory, and so on.

FIG. 2 is a block diagram of a system 200 including computer-readable media 204 and instructions 210-250 according to an example. The instructions include characterization instructions 210, allocation instructions 220, scheduling instructions 230, speculative instructions 240, and compression instructions 250 according to an example. The computer-readable media 204 is associated with a processor 202 and information 212, which pertains to memory devices of a computing system. The characterization instructions 210 may be used to identify which memory devices are cooler, and/or which memory devices are warmer. Such identification can be made based on monitored temperatures or stored characterization profiles. The characterization instructions 210 may correspond to the characterization engine 110 of FIG. 1. The allocation instructions 220 may be used to allocate pages of memory to memory devices based on expected temperature exposure and/or stored characterization profiles. The allocation instructions 220 may correspond to the allocation engine 120 of FIG. 1. The scheduling instructions 230 may be used to schedule memory usage based on expected temperature exposure and/or stored characterization profiles. The scheduling instructions 230 may correspond to a scheduling engine (not specifically shown in FIG. 1) that may be included in the controller 100 of FIG. 1. The speculative instructions 240 may be used to perform speculative background current sensing for cooler memory devices by proactively reading and storing background currents after writes to the cooler memory devices, to further speed up subsequent accesses. The speculative instructions 240 may correspond to a speculative engine (not specifically shown in FIG. 1) that may be included in the controller 100 of FIG. 1. The compression instructions 250 may be used to compress memory contents and fill space vacated by compression based on expected temperature exposure and/or stored characterization profiles. The compression instructions 250 may correspond to a compression engine (not specifically shown in FIG. 1) that may be included in the controller 100 of FIG. 1.

In some examples, operations performed when instructions 210-250 are executed by processor 202 may correspond to functionality of engines 110, 120 (and other corresponding engines as set forth above, not specifically illustrated in FIG. 1). Thus, in FIG. 2, the operations performed when instructions 210 are executed by processor 202 may correspond to functionality of characterization engine 110 (FIG. 1). Similarly, the operations performed when allocation instructions 220 are executed by processor 202 may correspond to functionality of allocation engine 120 (FIG. 1). Operations performed when instructions 230-250 are executed by processor 202 may correspond to functionality of corresponding engines (not specifically shown in FIG. 1).

As set forth above with respect to FIG. 1, engines 110, 120 may include combinations of hardware and programming. Such components may be implemented in a number of fashions. For example, the programming may be processor-executable instructions stored on tangible, non-transitory computer-readable media 204 and the hardware may include processor 202 for executing those instructions 210-250. Processor 202 may, for example, include one or multiple processors. Such multiple processors may be integrated in a single device or distributed across devices. Media 204 may store program instructions, that when executed by processor 202, implement system 100 of FIG. 1. Media 204 may be integrated in the same device as processor 202, or it may be separate and accessible to that device and processor 202.

In some examples, program instructions can be part of an installation package that when installed can be executed by processor 202 to implement system 100. In this case, media 204 may be a portable media such as a CD, DVD, flash drive, ora memory maintained by a server from which the installation package can be downloaded and installed. In another example, the program instructions may be part of an application or applications already installed. Here, media 204 can include integrated memory such as a hard drive, solid state drive, or the like. While in FIG. 2, media 204 includes instructions 210-250, one or more instructions may be located remotely from media 204. Conversely, although FIG. 2 illustrates information 212 located separate from media 204, the information 212 may be included with media 204.

The computer-readable media 204 may provide volatile storage, e.g., random access memory for execution of instructions. The computer-readable media 204 also may provide non-volatile storage, e.g., hard disk or solid state disk for storage. Components of FIG. 2 may be stored in any type of computer-readable media, whether volatile or non-volatile. Content stored on media 204 may include images, text, executable files, scripts, or other content that may be used by examples as set forth below. For example, media 204 may contain configuration information or other information that may be used by engines 110, 120 and/or instructions 210-250 to provide control or other information.

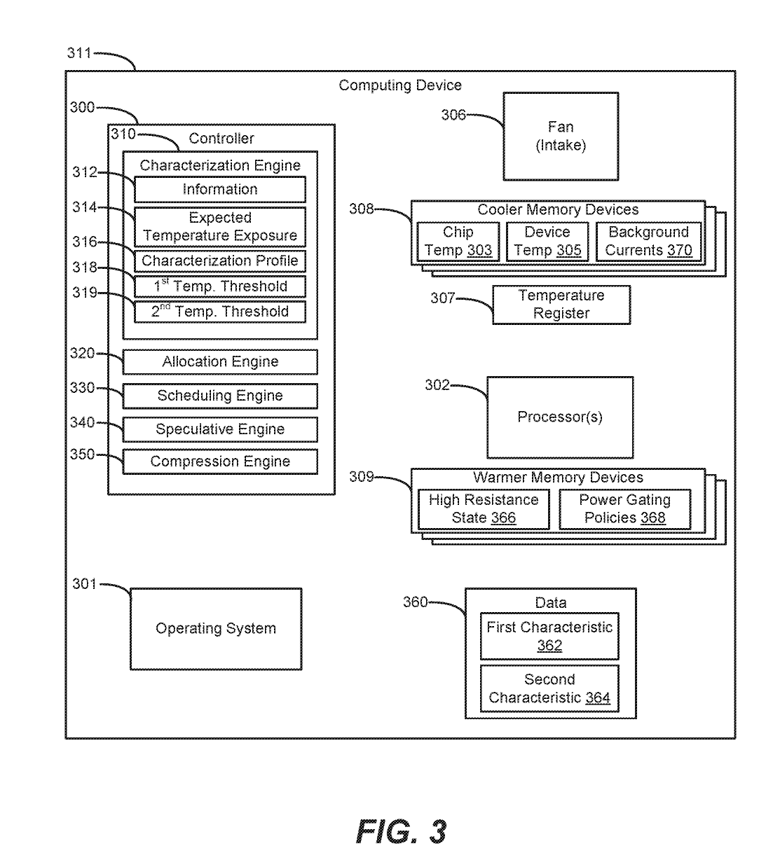

FIG. 3 is a block diagram of a computing device 311 including a controller 300 according to an example implementation. The computing device 311 also includes operating system 301, fan 306, cooler memory devices 308, temperature register 307, processor(s) 302, warmer memory devices 309, and data 360. The controller 300 includes characterization engine 310, allocation engine 320, scheduling engine 330, speculative engine 340, and compression engine 350. The characterization engine 310 is associated with information 312, expected temperature exposure 314, characterization profile 316, first temperature threshold 318, and second temperature threshold 319. The cooler memory devices 308 are associated with chip temperature 303, device temperature 305, and background currents 370. The warmer memory devices 309 are associated with high resistance state 366 and power gating policies 368. The data 360 is associated with a first characteristic 362 and a second characteristic 364.

As illustrated, in a given computing device 311/enclosure, a cooling source (fan 306) may be positioned on one side, to cause airflow to flow over memory devices 308, 309, processor(s) 302, and other components, to be exhausted from the computing device 311. Accordingly, the airflow/cooling and location of heat-generating components can result in temperature gradients, e.g., on the order of 20 degrees Celsius (C.), within the computing device 311. Such temperature gradients can result in different memory devices 308, 309 experiencing different temperatures. Example implementations described herein can exploit the different temperatures experienced by the memory devices 308, 309. For example, the characterization engine 310 can keep track of information 312 including location of memory devices 308, 309, and their proximity to cooling (such as fan 306) and/or heating (processor(s) 302). Such information can be used to identify expected temperature exposure 314 and to store a characterization profile 316 for the memory devices 308, 309.

Memory devices 308, 309 can be exposed to different temperatures in a computing device 311. For memristor-based memory devices in particular, the characteristics of the cells/chips of the memory devices 308, 309 can play an important role in overall energy usage and performance. For example, in a memristor-based memory device including selectors, a temperature increase from 50 degrees C. to 85 degrees C. can result in selector leakage current increasing from 900 nano amps (nA) to 1900 nA (at a 1 volt (V) selector bias), greatly increasing the overall sneak current in the crossbar memory array of the memory device. At the computing device/system level, it is possible to leverage the fact that memristor memory devices closer to cooling sources (fan 306) in an enclosed space can operate at more than 20 degrees C. cooler than other memory devices. This temperature difference can lead to differences in the sneak currents between those memory devices, causing some memory devices to be more power efficient and perform faster than others.

The controller 300 can gather information 312 on memory devices 308 at various levels of specificity. For example, every chip in a memory device can include a temperature sensor to obtain chip temperatures 303. A given memory device 308 can include a sensor to obtain a temperature for that memory device 308 in the form of device temperature 305. Example controllers 300 can achieve productive results without a need to track every temperature change of memory devices 308, 309. Rather, the controller 300 can characterize the information 312 of memory devices 308, 309 in a broad manner (e.g., including inferring temperature information based on location/proximity to heating/cooling), building characterization profiles 316. The characterization engine 310 can use first and second temperature thresholds 318, 319 to identify memory devices 308 as cooler (e.g., if not exceeding the first temperature threshold 318) or warmer (e.g., if exceeding the second temperature threshold 319). In alternate example implementations, a single threshold can be used (e.g., the first and second temperature thresholds 318, 319 can be set to equal one another), and relative comparisons between different memory devices can be used (e.g., whether a given memory device has an expected temperature exposure 314 warmer or cooler than an average of other memory devices). Thus, example controller 300 does not need to rely on or provide extremely granular/particular information 312. In some alternate examples, the controller can use location information 312 to identify two different location regions, e.g., a first (cooler) region closer to fan 306, and a second (warmer) region closer to processor(s) 302. Accordingly, expected temperature exposure 314, and characterization profile 316, can be based on location information 312, temperature information 312, and other characteristics of the memory devices 308, 309 that can affect their expected temperature exposure (e.g., whether a memory device is located in a direct airflow circulation path). Accordingly, real-time temperature sensor information is not needed to characterize whether a given memory device is to be treated as cooler 308 or warmer 309. In contrast, it is possible at a given time that a memory device treated as cooler 308 can experience a temperature warmer than a memory device treated as warmer 309, and vice versa. Thus, the controller 300 can develop and rely on information provided by the expected temperature exposure 314 and characterization profile 316, even if a given sensor reading is to the contrary at some point (e.g., following system downtime, where operational device temperatures/airflows have not yet stabilized or reached full operating temperatures).

The characterization engine 310 can characterize a given memory device location as cooler or warmer, e.g., according to first and second temperature thresholds 318, 319. Thus, temperature information 312 can be observed by the characterization engine 310 over long periods of time to identify a general correspondence between temperatures of memory devices 308, and their locations in the computing device 311. Accordingly, the characterization engine 310 can collect temperature information 312 and locations from some memory devices, and infer expected temperature exposure 314 for other memory devices (without collecting their temperature information) based on the location information 312 for those memory devices. The characterization engine 310 can obtain the information 312 from a temperature register 307 indicative of a temperature for a location region in the computing device 311, at a granularity down to groups of memory devices 308/309 of the computing device 311 associated with the location region. The characterization engine 310 also can obtain the information 312 from a temperature readout of a memory device 308 in a computing device 311, to obtain device temperature 305 at a granularity down to individual memory devices of the computing device 311. Also, the characterization engine 310 can obtain the information 312 from a temperature readout of a chip of a memory device 308 in a computing device 311, to obtain chip temperature 303 at a granularity down to individual chips of memory devices 308 of the computing device 311.

The allocation engine 320 and the scheduling engine 330 can use thermal-aware page allocation and scheduling policies, to maximize utilization of low-temperature regions of memory devices 308, associated with less leakage current, to improve read and write energies. Furthermore, the allocation engine 320 and the scheduling engine 330 can improve write performance by directing memory requests to cooler memory devices 308, to reduce write latencies.

The allocation engine 320 can provide, or instruct the operating system 301 to provide, memory to applications. In some example implementations, the allocation engine 320 prioritizes the allocation of memory from the cooler memory devices 308.

The scheduling engine 330 can schedule memory accesses/requests. In some example implementations, the scheduling engine 330 is to prioritize scheduling accesses to the cooler memory devices 308. This has the effect of speeding up access to memory. In general, allocation and scheduling go hand-in-hand, to allocate and maximize access to the cooler memory devices 308.

The operating system (OS) 301 can interact with the various engines 310-350 to enhance performance of the computing device 311. For example, the allocation engine 320 can provide the expected temperature exposure 314 of memory devices 308, 309 to the OS 301 of the computing device 311, to enable the OS 301 to interact with the engines 310-350 and share the expected temperature exposure 314. By exposing the operating temperature of various memory devices 308, 309 to the OS 301, the OS and/or allocation engine 320 can instruct the OS 301 to allocate new pages to prioritize and exhaust free pages in the cooler memory devices 308. The engines 310-350 can interact with the OS 301 based on various application programming interfaces (APIs) regarding passing information 312, expected temperature exposure 314, and/or characterization profile 316. The OS 301, for example, can access temperature readings through an API accessing system temperature that is mapped to the temperature register 307. Information can be obtained by the engines 310-350, and/or exchanged with the OS 301, periodically (e.g., at time intervals or in response to changes to memory pages), and/or constantly monitored.

The engines 310-350 can interact with memory 308, 309 based on characteristics of the data 360. In some example implementations, the allocation engine 320 can prioritize page allocation to cooler memory devices 308 based on a first characteristic 362 of data 360 associated with the page to be allocated. For example, metadata for a database can be prioritized for high performance associated with cooler memory devices 308. The allocation engine 320 can prioritize page allocation to warmer memory devices 309 based on a second characteristic 364 of data 360 associated with the page to be allocated (e.g., even if cooler memory devices 308 are still available). For example, the computing device 311 may want to treat the large amounts of data to be searched as having lower performance needs, and use that characteristic to put the raw data in warmer memory devices 309. Software APIs can be used to identify and communicate characteristics of the data 360 to the engines 310-350. For example, databases can use memory as a primary data store (e.g. an application server that includes an in-memory, column-oriented, relational database management system such as SAP HANA®). Such workloads have well-defined and easily communicated (via API) memory regions to store metadata, which is more frequently accessed than other regions such as the data. The cooler memory devices 308 and the warmer memory devices 308 can be used to exploit data 360 of the application using well-defined boundaries as indicated by the first characteristic 362 and the second characteristic 364, such that more performance-oriented data 360 can be mapped to cooler memory devices 308, and less performance-oriented data 360 can be mapped to warmer memory devices 309. Accordingly, example implementations are not limited to giving out cold memory pages until exhausted. Rather, the engines 310-350 can selectively send some data 360 to warmer memory devices 309 based on characteristics 362, 364 of the data 360, even if cooler memory is available.

The compression engine 350 is to compress memory contents of the cooler and/or warmer memory devices 308, 309. The compression engine 350 can enable the controller 300 to fill space vacated by the compression in cooler memory devices 308 with additional data (such as the next cache line), thereby maximizing capacity of the cooler memory devices 308. The compression engine 350 can fill space vacated by the compression in warmer memory devices 309 with a high resistance state 366, to minimize sneak current of the warmer memory devices 309 and saving power consumption. The compression engine 350 can use low-complexity compression techniques on the memory devices 308, 309 (e.g., those techniques associated with an overhead of less than on the order of 2 nanoseconds). The compression engine 350 can thereby grow effective memory capacity of cooler memory devices 308, and grow the percentage of high resistance states (reducing sneak current) in warmer memory devices 309. In an example implementation, increasing the high resistance states from 50% to 75%, in a crossbar memory array using memristor memory devices, reduces energy usage by 6%. Thus, compression engine 350 enables thermal-aware compression for controller 300 and its memory 308, 309 to maximize the capacity of cooler regions and minimize sneak current in warmer regions. In an example, the compression engine 350 can instruct the OS 301 to handle page-level memory compression.

The speculative engine 340 can use speculative background current sensing for cooler memory devices 308, by proactively reading and storing background currents 370 after writes to the cooler memory devices 308. This has the benefit of further speeding up subsequent memory accesses. In general, a memristor array memory device performs a memory read based on two reads, by performing a first noisy read of current through a selected memory cell, and by performing a second read of the background sneak currents (to cancel out the noise from the first read). The latter measurement (the second read of background sneak currents) can be re-used when reading other cells in the same column of the memory array. Because a given example implementation can result in channeling more memory requests to cooler memory devices, speculative background current sensing can be used to further speed up accesses to cooler memory devices 308. In contrast, aggressive power gating policies 368 can be used on warmer memory devices 308 to reduce power consumption of the warmer memory devices 309. Power gating policies 368 affect how frequently, regarding memory cycles, a read request is performed versus putting the memory in sleep/power-down mode (and the associated penalty of waking up the memory from sleep). Aggressive power gating policies 368 can reduce the delta of putting memory into sleep mode, to consume less power (less leakage current) and reduce temperatures.

Thus, in some example implementations, the controller 300 can proactively read the background current after a write, so that if the next memory read request falls to the same memory array, the background current is already ready to be used for noise subtraction, enabling memory access times to be much shorter. Additionally, the speculative engine 340 can go beyond reusing background current as discussed above, because the speculative engine 340 can speculatively read and store background currents. Speculation has a risk of wasting energy when the speculation turns out to be incorrect, so it is better to use speculation on higher performance memory (e.g., cooler memory devices 308). The background current that is read is valid for a short time, and for a certain memory region, and more aggressive speculation can be used by the speculative engine 340, because use of the cooler memory devices 308 is relatively more efficient and can afford the increased aggression.

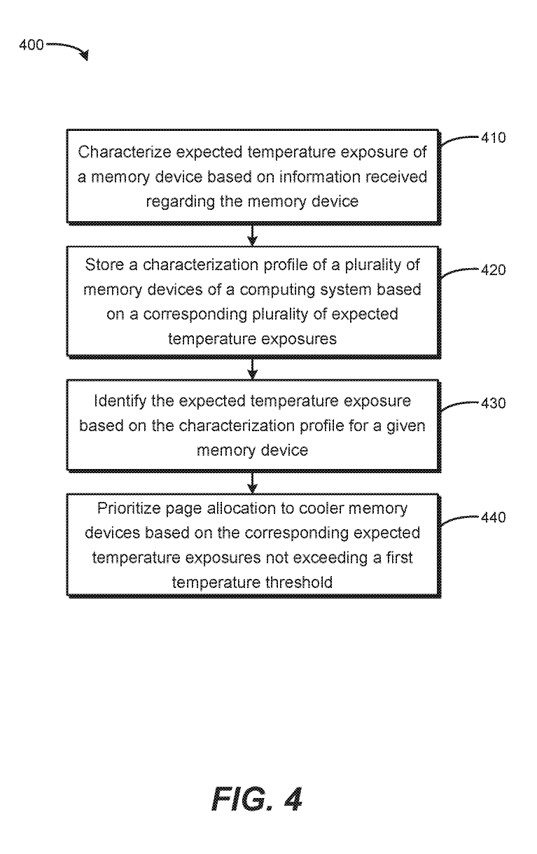

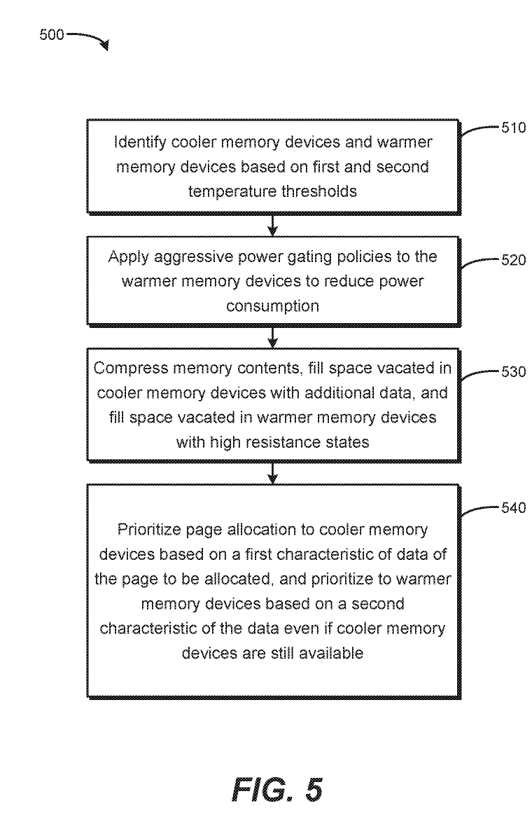

Referring to FIGS. 4 and 5, flow diagrams are illustrated in accordance with various examples of the present disclosure. The flow diagrams represent processes that may be utilized in conjunction with various systems and devices as discussed with reference to the preceding figures. While illustrated in a particular order, the disclosure is not intended to be so limited. Rather, it is expressly contemplated that various processes may occur in different orders and/or simultaneously with other processes than those illustrated.

FIG. 4 is a flow chart 400 based on identifying expected temperature exposure based on a characterization profile according to an example. In block 410, expected temperature exposure of a memory device is characterized based on information received regarding the memory device. For example, a characterization engine can receive location information of a given memory device, and infer an expected temperature exposure of that memory device based on temperature information from other memory devices sharing its location region. In block 420, a characterization profile of a plurality of memory devices of a computing system can be stored based on a corresponding plurality of expected temperature exposures. For example, the characterization engine can identify a profile of a given computing system based on some collected data, to identify trends in temperature information that may deviate from instantaneous temperature readings of memory devices. In block 430, the expected temperature exposure is identified based on the characterization profile for a given memory device. For example, the characterization engine can refer to the stored characterization profile to determine whether a given memory device is warmer or cooler, regardless of a memory device's present sensed temperature. In block 440, page allocation to cooler memory devices can be prioritized based on the corresponding expected temperature exposures not exceeding a first temperature threshold. For example, an allocation engine can prioritize allocation of memory to memory devices whose expected temperature exposure falls below an average temperature threshold as determined among other memory devices.

FIG. 5 is a flow chart 500 based on prioritizing cooler memory devices and warmer memory devices according to an example. In block 510, cooler memory devices and warmer memory devices are identified based on first and second temperature thresholds. For example, a characterization engine can identify cooler memory devices that are relatively cooler than other memory devices based on an average temperature, and warmer memory devices that are relatively warmer than the average temperature (e.g., the first and second temperature thresholds can be equal to each other). In block 520, aggressive power gating policies are applied to the warmer memory devices to reduce power consumption. For example, regardless of present sensed memory temperatures, those memory devices characterized as warmer can be aggressively power gated to put them in power-down mode and minimize leakage current. In block 530, memory contents are compressed, to fill space vacated in cooler memory devices with additional data, and to fill space vacated in warmer memory devices with high resistance states. For example, a compression engine can direct a controller to fill those memory devices, characterized as cooler, with data from the next cache line. The compression engine can direct the controller to fill those memory devices, characterized as warmer, with high resistance states to minimize leakage current. In block 540, page allocation can be prioritized to cooler memory devices based on a first characteristic of data of the page to be allocated, and prioritize to warmer memory devices based on a second characteristic of the data even if cooler memory devices are still available. For example, allocation/scheduling engines can identify that data is associated with higher performance metadata of a database, and store that information in cooler memory devices. The engines can also identify that data corresponds to raw data of the database, and store that lower-performance raw data in warmer memory devices to leave more space available in the cooler memory devices.

Examples provided herein may be implemented in hardware, software, or a combination of both. Example systems can include a processor and memory resources for executing instructions stored in a tangible non-transitory medium (e.g., volatile memory, non-volatile memory, and/or computer readable media). Non-transitory computer-readable medium can be tangible and have computer-readable instructions stored thereon that are executable by a processor to implement examples according to the present disclosure.

An example system (e.g., including a controller and/or processor of a computing device) can include and/or receive a tangible non-transitory computer-readable medium storing a set of computer-readable instructions (e.g., software, firmware, etc.) to execute the methods described above and below in the claims. For example, a system can execute instructions to direct a characterization engine to characterize memory as relatively cooler or warmer, wherein the engine(s) include any combination of hardware and/or software to execute the instructions described herein. As used herein, the processor can include one or a plurality of processors such as in a parallel processing system. The memory can include memory addressable by the processor for execution of computer readable instructions. The computer readable medium can include volatile and/or non-volatile memory such as a random access memory (“RAM”), magnetic memory such as a hard disk, floppy disk, and/or tape memory, a solid state drive (“SSD”), flash memory, phase change memory, and so on.

What is claimed is:

1. A controller comprising:
a characterization engine to receive information regarding a memory device, and to characterize expected temperature exposure of the memory device based on the information, wherein the characterization engine is to store a characterization profile of a plurality of memory devices of a computing system based on the expected temperature exposures for the plurality of memory devices, and refer to the characterization profile to identify the expected temperature exposure for a given memory device; and
an allocation engine to prioritize page allocation to the memory device based on the expected temperature exposure.

2. The controller of claim 1, wherein the characterization engine is to characterize a given memory device location as cooler according to whether the expected temperature exposure does not exceed a first temperature threshold, and characterize the given memory device location as warmer according to whether the expected temperature exposure exceeds a second temperature threshold.

3. The controller of claim 1, wherein the characterization engine is to obtain the information from a temperature register indicative of a temperature for a location region in a computing system, at a granularity down to groups of memory devices of the computing system associated with the location region.

4. The controller of claim 1, wherein the characterization engine is to obtain the information from a temperature readout of a memory device in a computing system, at a granularity down to individual memory devices of the computing system.

5. The controller of claim 1, wherein the characterization engine is to obtain the information from a temperature readout of a chip of a memory device in a computing system, at a granularity down to individual chips of memory devices of the computing system.

6. The controller of claim 1, wherein the information is a location of the memory device, and wherein the characterization engine is to identify the location relative to heat sources and airflow in the computing system to infer the expected temperature exposure of the memory device relative to other memory devices and their locations.

7. The controller of claim 1, wherein the allocation engine is to provide the expected temperature exposure of the memory device to an operating system (OS) of the computing system, to enable the OS to interact with the engines and share the expected temperature exposure.

8. The controller of claim 1, wherein the allocation engine is to prioritize page allocation to cooler memory devices based on a first characteristic of data associated with the page to be allocated, and to prioritize page allocation to warmer memory devices based on a second characteristic of data associated with the page to be allocated even if cooler memory devices are still available.

9. The controller of claim 1, further comprising a compression engine to compress memory contents of the memory device, and to fill space vacated by the compression in cooler memory devices with additional data to maximize capacity of the cooler memory devices.

10. The controller of claim 9, wherein the compression engine is to fill space vacated by the compression in warmer memory devices with a high resistance state to minimize sneak current of the warmer memory devices.

11. The controller of claim 1, further comprising a speculative engine to use speculative background current sensing for cooler memory devices by proactively reading and storing background currents after writes to the cooler memory devices to further speed up subsequent accesses.

12. A method, comprising:
characterizing expected temperature exposure of a memory device based on information received regarding the memory device;
storing a characterization profile of a plurality of memory devices of a computing system based on a corresponding plurality of expected temperature exposures;
identifying the expected temperature exposure based on the characterization profile for a given memory device; and
prioritizing page allocation to cooler memory devices based on the corresponding expected temperature exposures not exceeding a first temperature threshold.

13. The method of claim 12, further comprising identifying warmer memory devices based on the expected temperature exposure exceeding a second temperature threshold; and applying aggressive power gating policies to the warmer memory devices to reduce power consumption.

14. A non-transitory machine-readable storage medium encoded with instructions executable by a computing system that, when executed, cause the computing system to:
characterize, by a characterization engine, expected temperature exposure of a memory device based on information received regarding the memory device;
store a characterization profile of a plurality of memory devices of a computing system based on a corresponding plurality of expected temperature exposures;
identify the expected temperature exposure based on the characterization profile for a given memory device;
compress, by a compression engine, memory contents of the memory device; and
fill space vacated by compression in cooler memory devices with additional data to maximize capacity of the cooler memory devices, wherein cooler memory devices are associated with corresponding expected temperature exposures not exceeding a first temperature threshold.

15. The storage medium of claim 14, further comprising instructions that cause the computing system to fill space vacated by compression in warmer memory devices with a high resistance state to minimize sneak current of the warmer memory devices, wherein warmer memory devices are associated with corresponding expected temperature exposures exceeding a second temperature threshold.
